(19) United States
(12) Patent Application Publication
(10) Pub. No.: US 2011/0076642 A1
(43) Pub. Date: Mar. 31, 2011

(54) Dental Implant Fixture

(76) Inventor: Ju Won Choi, Gyeongsangnam-do (KR)

(21) Appl. No.: 12/664,051

(22) PCT Filed: Dec. 1, 2008
(86) PCT No.: PCT/KR2008/007097

§ 371 Date: Dec. 10, 2009

(30) Foreign Application Priority Data
Jun. 18, 2008 (KR) 20-2008-0008130

(51) Int. Cl. A61C 13/225

(52) U.S. Cl. 433/172

(57) ABSTRACT

Provided is a dental implant fixture with 3 or more ridged portions having mutually different pitches to distribute load uniformly across osseous tissue. The pitches of the ridged portions (200) progressively decrease in one direction. The ridged portions (200) include a larger ridged portion (220) that contacts spongy bone with low bone density, and a smaller ridged portion (240) that contacts cortical bone with high bone density. The smaller ridged portion (240) is provided with 2 or more threaded regions with respectively different pitches. With this configuration, bone decay and bone damage can be prevented, and synostosis can be improved.

### TECHNICAL FIELD

The present disclosure relates to a dental implant fixture provided with 3 or more ridged portions having mutually different pitches to distribute load uniformly across osseous tissue.

### BACKGROUND ART

While implants in general denote replacement material for restoring lost human anatomical components, in dentistry, implants are prosthetic tooth roots that allow prosthetic teeth to be implanted.

Specifically, a dental implant fixture is usually made of titanium that the human body does not reject in order to replace roots of teeth that are lost, and are implanted and fixed in bone from which teeth have fallen cut. Prosthetic teeth are fixed to such implants to restore the functions of lost teeth.

While other types of prosthetic or false teeth degenerate the surrounding teeth or bone over time, implants do not induce degeneration of surrounding teeth. Also, implants are virtually the same in terms of function and form as the original natural teeth they replace, and are not prone to cavities. In addition, because implants can be used almost indefinitely, they are the subject of much research and development.

Below, the structure of a related art implant will be described with reference to FIG. 1.

FIG. 1 is a view showing the structure of a related art dental implant fixture in use.

Referring to FIG. 1, a fixture 10 is synostosed with the dental alveolus 20 by being screwed and fixed therein.

Specifically, the dental alveolus 20 includes a cortical bone 22 that is hard with high bone density, and a spongy bone 24 disposed below the cortical bone 22 and having low bone density. The fixture 10 is screwed and fixed in both the cortical bone 22 and spongy bone 24.

To achieve the latter, a ridged portion 12 is formed in the cuter periphery of the fixture 10. The ridged portion 12 is formed in the shape of screw threads to increase its surficial contacting area with the dental alveolus 20 and uniformly distribute stress.

However, the following limitations are inherent in the above-configured fixture 10 according to the related art.

Specifically, the related art ridged portion 12 is machined and defined in the cuter periphery of the fixture 10 with the same pitch. Therefore, an implant hole (not shown) rust be precisely machined in order to implant the fixture 10 in the dental alveolus 20.

If the implant hole is not precisely machined, the coupling force with the ridged portion 12 and dental alveolus 20 is deteriorated, thus lowering synostotic integrity.

For the above reason, the fixture 10 is difficult to be implanted successfully, and the bone decay and bone damage can be resulted because load cannot be uniformly distributed.

### DISCLOSURE OF INVENTION

### Technical Problem

Embodiments provide a dental implant fixture provided with 3 or more ridged portions having mutually different pitches to distribute load uniformly across osseous tissue, in order to prevent bone decay and bone damage and improve synostosis.

### Technical Solution

In one embodiment, a dental implant fixture includes 3 or more ridged portions defined in an outer periphery thereof having respectively different pitches.

The pitches of the ridged portions may progressively decrease in one direction.

The ridged portions may include a larger ridged portion contacting a spongy bone having a low bone density, and a smaller ridged portion contacting a cortical bone having a high bone density, wherein the smaller ridged portion may include 2 or more threaded regions having respectively different pitches.

The pitches of the threaded regions may progressively decrease away from the larger ridged portion.

The threaded regions may include a first threaded region defined proximate to the larger ridged portion, and a second threaded region having a smaller pitch than the first threaded region, wherein the first threaded region and the second threaded region may be defined along the outer periphery of the dental implant fixture to extend a same height, respectively.

The pitch of the first threaded region may be twice the pitch of the second threaded region.

The threaded regions may include a first threaded region defined proximate to the larger ridged portion, a second threaded region having a smaller pitch than the first threaded region, and a third threaded region having a smaller pitch than the second threaded region, wherein the first threaded region, the second threaded region, and the third threaded region may be defined along the outer periphery of the dental implant fixture to extend a same height, respectively.

The pitch of the first threaded region may be twice the pitch of the second threaded region, and the pitch of the second threaded region may be twice the pitch of the third threaded region.

The smaller ridged portion may be defined in the cuter periphery of the dental implant fixture to extend a height of 2.6 mm or less.

### Advantageous Effects

The above-configured dental implant fixture according to present embodiments is provided with 3 or more ridged portions in cuter periphery with mutually different pitches.

Therefore, by uniformly distributing load across osseous tissue, bone decay and bone damage can be prevented.

Also, a dental implant fixture configured according to present embodiments has screw threads that decrease in pitch along one direction.

Because machining process of the screw threads is scientific, defects can be reduced, and total productivity can be increased.

### BRIEF DESCRIPTION OF THE DRAWINGS

FIG. 1 is a view showing the structure of a related art dental implant fixture in use.

FIG. 2 is an upward perspective view of a dental implant fixture according to a present embodiment.

FIG. 3 is a view showing an implanted dental implant fixture according to a present embodiment.

FIG. 4 is a cross-sectional view showing the structure of a dental implant fixture according to a present embodiment.

FIG. 5 is a cross-sectional view showing the structure of a dental implant fixture according to another present embodiment.

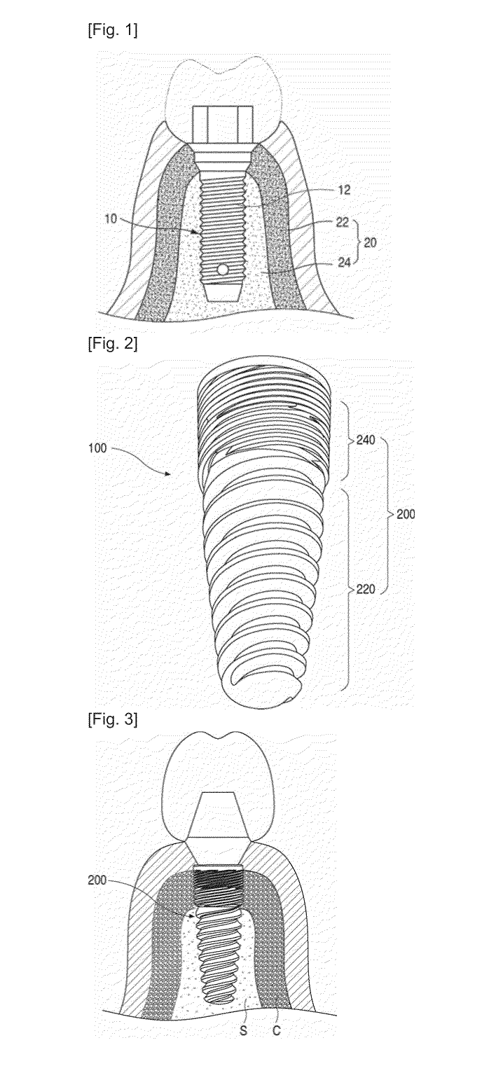

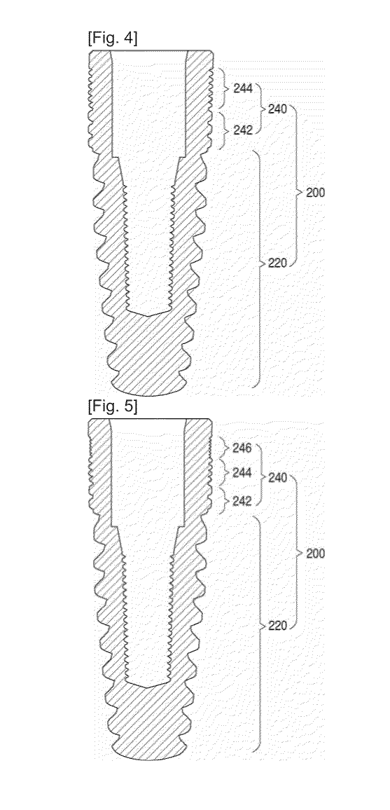

### MODE FOR THE INVENTION

A description will be provided below of the structure of a dental implant fixture (hereinafter called a ‘fixture’) according to present embodiments, with reference to FIGS. 2 and 3.

FIG. 2 is an upward perspective view of a dental implant fixture according to a present embodiment, and FIG. 3 is a view showing an implanted dental implant fixture according to a present embodiment.

Referring to FIGS. 2 and 3, a fixture 100 according to present embodiments is shaped as a column with screw threads defined in its alter periphery, and is implanted in a dental alveolus (not shown).

Specifically, the cuter periphery of the fixture 100 is provided with three or more parts of ridged portions 200 having mutually different pitches, and the ridged portions 200 progressively decrease in pitch upward.

Accordingly, the ridged portions 200 have an upper outer peripheral pitch that is less than the lower cuter peripheral pitch.

The ridged portions 200 are configured to include a larger ridged portion 220 that contacts the spongy bone (S) with less bone density, and a smaller ridged portion 240 that contacts the cortical bone (C) with higher bone density than the spongy bone (S).

The smaller ridged portion 240 is provided with 2 or more threaded regions with mutually different pitches. The threaded regions provided in the smaller ridged portion 240 are configured to have a pitch that progressively decreases away from the larger ridged portion 220.

That is, the screw threads are configured to include a first threaded region 242 formed proximate to the larger ridged portion 220, and a second threaded region 244 having a pitch less than the first threaded region 242.

The pitch of the first threaded region 242 is twice the pitch of the second threaded region 244.

This is to increase the surface area of the smaller ridged portion 240 when it is inserted into and contacts the cortical bone (C) to distribute load evenly, and the larger ridged portion 220 may be configured to have a pitch that decreases progressively upward.

For example, if the pitch of the first threaded region 242 is 0.4 mm, the pitch of the second threaded region 244 is 0.2 mm.

Further, the pitch of the larger ridged portion 220 may be formed 2 or 4 times the pitch of the first threaded region 242.

For example, if the pitch of the first threaded region 242 is 0.4 mm, the pitch of the larger ridged portion 220 may be 0.8 mm or 1.6 mm.

This is to simultaneously raise the machinability and productivity of the ridged portion 200 and improve synostosis.

In further detail, in case the pitch of the larger ridged portion 220 is 0.8 mm, the pitch of the first threaded region 242 is 0.4 mm, and the pitch of the second threaded region 244 is 0.2 mm, even if the larger ridged portion 220, the first threaded region 242, and the second threaded region 244 are sequentially formed when defining the ridged portion 200 in the cuter periphery of the fixture 100, because the ridged portion that is machined afterward is not cut away and is retained, screw threads are ultimately not omitted (as shown in FIGS. 2 and 3).

For the above reason, synostosis is improved.

The first threaded region 242 and the second threaded region 244 are defined over the same height in the cuter periphery of the fixture 100. That is, according to an embodiment of the present invention, the first threaded region 242 is defined over a height of 1.3 mm, and the second threaded region 244 is also defined over a height of 1.3 mm.

Also, the height including the first threaded region 242 and the second threaded region 244—that is, the height of the smaller ridged portion 240—is 2.6 mm or less.

This is to account for the fact that the thickness of a normal cortical bone (C) with a higher bone density in the dental alveolus is 3.0 mm or less, and that when the first threaded region 242 and the second threaded region 244 are implanted in the spongy bone (S), their effectiveness is easily reduced.

Below, a description of the fixture 100 configured according to another embodiment will be provided with reference to FIG. 5.

FIG. 5 is a cross-sectional view showing the structure of a dental implant fixture according to another present embodiment.

Referring to the diagrams, in a fixture 100 according to another embodiment, 3 threaded regions having mutually different pitches are defined in the smaller ridged portion 240.

That is, the threaded regions defined in the smaller ridged portion 240 include a first threaded region 242 defined proximate to the larger ridged portion 220, a second threaded region 244 with a pitch less than that of the first threaded region 242, and a third threaded region 246 with a pitch less than that of the second threaded region 244.

The height over which the first threaded region 242, the second threaded region 244, and the third threaded region 246 are defined is 2.6 mm or less, as in the former present embodiment, and the first threaded region 242, the second threaded region 244, and the third threaded region 246 are respectively defined over the same height.

For example, given that the height of the smaller ridged portion 240 is 2.4 mm, the first threaded region 242, the second threaded region 244, and the third threaded region 246 are formed to have respective heights of 0.8 mm.

Also, the pitch of the first threaded region 242 is twice the pitch of the second threaded region 244, and the pitch of the second threaded region 244 is twice the pitch of the third threaded region 246.

For example, if the pitch of the first threaded region 242 is 0.4 mm, the pitch of the second threaded region is 0.2 mm, and the pitch of the third threaded region 246 is 0.1 mm.

Here, the pitch of the larger ridged portion 220 is 0.8 mm or 1.6 mm. Of course, when considering that the pitch of the larger ridged portion 220 is 1.6 mm and the height of the cortical bone (C) is 2.6 mm or less, while the combined height of the first threaded region 242 through the third threaded region 246 and the larger ridged portion 220 may exceed 2.6 mm, the pitch of 1.6 mm has been exemplarily provided for the first threaded region 242 through the third threaded region 246 and the larger ridged portion 220, respectively, to facilitate understanding of the present invention.

The spirit and scope of the present invention are not limited to the above embodiments, and those having ordinary skill in the art will be able to devise numerous other modified embodiments based on the present invention.

For example, while 2 or 3 threaded regions having mutually different pitches have been configured in the smaller ridged portion according to present embodiments, 4 or more threaded regions having respectively different pitches that decrease along one direction may be provided.

1. A dental implant fixture comprising three or more ridged portions defined in an alter periphery thereof, the ridged portions having respectively different pitches.

2. The dental implant fixture according to claim 1, wherein the pitches of the ridged portions progressively decrease in one direction.

3. The dental implant fixture according to claim 2, wherein the ridged portions comprise:
a larger ridged portion contacting a spongy bone having a low bone density; and
a smaller ridged portion contacting a cortical bone having a high bone density,
wherein the smaller ridged portion comprises 2 or more threaded regions having respectively different pitches.

4. The dental implant fixture according to claim 3, wherein the pitches of the threaded regions progressively decrease away from the larger ridged portion.

5. The dental implant fixture according to claim 3, wherein the threaded regions comprise:
a first threaded region defined proximate to the larger ridged portion; and
a second threaded region having a smaller pitch than the first threaded region,
wherein the first threaded region and the second threaded region are defined along the outer periphery of the dental implant fixture to extend a same height, respectively.

6. The dental implant fixture according to claim 5, wherein the pitch of the first threaded region is twice the pitch of the second threaded region.

7. The dental implant fixture according to claim 3, wherein the threaded regions comprise:
a first threaded region defined proximate to the larger ridged portion;
a second threaded region having a smaller pitch than the first threaded region; and
a third threaded region having a smaller pitch than the second threaded region,
wherein the first threaded region, the second threaded region, and the third threaded region are defined along the outer periphery of the dental implant fixture to extend a same height, respectively.

8. The dental implant fixture according to claim 7, wherein the pitch of the first threaded region is twice the pitch of the second threaded region, and the pitch of the second threaded region is twice the pitch of the third threaded region.

9. The dental implant fixture according to any one of claims 3 to 8, wherein the smaller ridged portion is defined in the cuter periphery of the dental implant fixture to extend a height of 2.6 mm or less.
